(19) United States
(12) Patent Application Publication
(10) Pub. No.: US 2024/0118427 A1
(43) Pub. Date: Apr. 11, 2024

(54) LIDAR SYSTEM, VEHICLE AND OPERATION METHOD

(71) Applicant: ams-OSRAM International GmbH, Regensburg (DE)

(72) Inventor: Reiner WINDISCH, Pettendorf (DE)

(21) Appl. No.: 18/255,590

(22) PCT Filed: Dec. 9, 2021
(86) PCT No.: PCT/EP2021/084973

§ 371 Date: Jun. 2, 2023

(30) Foreign Application Priority Data
Dec. 23, 2020 (DE) 10 2020 134 851.7

(51) Int. Cl. G01S 17/931; G01S 7/481; G01S 17/36; G01S 17/89

(52) U.S. Cl. CPC G01S 17/931; G01S 7/4811; G01S 17/36; G01S 17/89

(57) ABSTRACT

A Lidar system may include a first laser, a second laser, and a detection unit for detecting laser radiation of the first and second lasers. The first laser in a first wavelength range and the second laser in a second wavelength range may be configured for periodically tuning a respective emission wavelength. A first tuning time T1 of the first laser may differ from a second tuning time T2 of the second laser.

### CROSS-REFERENCE TO RELATED APPLICATIONS

The present application is a national stage entry according to 35 U.S.C. § 371 of PCT application No.: PCT/EP2021/084973 filed on Dec. 9, 2021; which claims priority to German patent application 10 2020 134 851.7, filed on Dec. 23, 2020; all of which are incorporated herein by reference in their entirety and for all purposes.

### TECHNICAL FIELD

A Lidar system is specified. Furthermore, a vehicle having such a Lidar system is disclosed. Further, a method for operating such a Lidar system is disclosed.

### BACKGROUND

Document WO 2020/081188 A1 concerns a Lidar system.

In document WO 2019/205163 A1 a Lidar system with multiple emitters and with multiple receivers can be found.

A Lidar system in which an angular range is scanned with at least two beams can be found in document US 2018/0284236 A1.

A Lidar system with wavelength multiplexing is known from document US 2019/0257927 A1.

An object to be solved is to specify a Lidar system with which a scan time per pixel can be reduced.

### SUMMARY

According to at least one embodiment, the Lidar system comprises a first laser and a second laser. The lasers may be solid-state lasers, in particular semiconductor lasers. The lasers may be formed by separate, structurally independent lasers or by a laser system with several monolithically integrated laser emission regions on a common semiconductor substrate.

According to at least one embodiment, the first laser in a first wavelength range and the second laser in a second wavelength range are configured for periodic tuning of a respective emission wavelength. For example, a tuning time, also referred to as a period duration or chirp, of the respective laser is constant. That is, the tuning times may not change over time as intended. In an embodiment, the wavelength ranges do not overlap.

According to at least one embodiment, the Lidar system comprises a detection unit for detecting laser radiation of the first and the second laser. In the detection unit, for example, a beat frequency of laser radiation directly from the laser in question and of laser radiation of the same laser reflected from at least one object outside the Lidar system is determined in each case. This may be done for each laser independently of the at least one other laser.

According to at least one embodiment, a first tuning time T1 of the first laser differs from a second tuning time T2 of the second laser. In other words, the lasers have different period durations, in particular no period durations that are integer multiples of each other.

In at least one embodiment, the Lidar system comprises a first laser and a second laser, and a detection unit for detecting laser radiation from the first laser and the second laser. The first laser is configured for a first wavelength range and the second laser is configured for a second wavelength range for periodically tuning a respective emission wavelength. A first tuning time T1 of the first laser is different from a second tuning time T2 of the second laser and/or a wavelength change per time of the first laser is different from a wavelength change per time of the second laser.

Because the lasers have different tuning times, a scan time per pixel can be smaller than a light runtime to the object to be detected and back to the Lidar system, while ambiguities in the position determination can still be avoided. Thus, overall shorter scan times for an image can be achieved and/or a number of pixels can be increased accordingly.

According to at least one embodiment, T1>T2 applies and the quotient T1/T2 is between and including 1.02 to 1.98 or between and including 1.05 to 1.95 or between and including 2.05 to 2.95 or between and including 3.05 to 3.95. In an embodiment, 1.05≤T1/T2≤1.7 or 1.05≤T1/T2≤1.6 or 1.1≤T1/T2≤1.5. In other words, the tuning times T1 and T2 differ noticeably from each other, but on the other hand again not too much.

According to at least one embodiment, at least one of the tuning times T1 and T2 is smaller by at least a factor of 2 or by at least a factor of 3 or by at least a factor of 5 than an intended maximum range R of the Lidar system divided by the vacuum light velocity c. In other words, T1, T2≤R/2c or T1, T2≤R/3c or T1, T2≤R/5c. Alternatively or additionally, this factor is at most 30, or at most 20, or at most 10, or at most 6.

According to at least one embodiment, m T1=n T2⇔T1=n/m T2 with m, n∈ [symbol] and m<n and n/m∈ [symbol] \ [symbol] . In other words, m and n are integers and the fraction m by n is not an integer.

According to at least one embodiment, for all i=1, . . . , n and for all j=1, . . . , m it applies:

$$\frac{im}{jn} \leq 0 , 990 ⋀ 1 , 010 \leq \frac{im}{jn} or \frac{im}{jn} \leq 0 , 97 ⋀ 1 , 03 \leq \frac{im}{jn} or \frac{im}{jn} \leq 0 , 95 ⋀ 1 , 05 \leq \frac{im}{jn} .$$

In an embodiment, this applies up to the intended maximum range R, which may be smaller than m T1 c. That is, it may further hold true that m T1>2 R/c and (m−1) T1≤2 R/c or m T1>R/c and (m−1) T1≤R/c, or in general m T1>F R/c and (m−1) T1≤F R/c with 0.2≤F≤2 or 0.2≤F≤1.5 or 0.3≤F≤1.2 or 0.4≤F≤0.9. A value of F<2 means that T1=k T2 with k ε [symbol] does not occur until well outside the intended maximum range R. That is, F can be considered a safety factor, so that potential ambiguities do not occur until well outside the intended maximum range R.

In other words, i and j are integer counting indices running from 1 to n and from 1 to m, respectively. For each fraction of i times m and of j times n, this fraction is not too close to one, and this is true within the intended maximum range R of the Lidar system. The Lidar system usually operates in air. Since the speed of light in air deviates only slightly from the vacuum speed of light, the vacuum speed of light c is used for the calculation of the time of flight over a distance.

For example, m=7 and n=9, so T1=9/7 T2. Up to a distance of 7c T1>R there is then no integer fraction from m and n. The tuning time sections of the second laser then end at 7/9 T1, at 14/9 T1, at 21/9 T1, at 28/9 T1 and so on. The tuning time sections of the first laser then end at 9/7 T2, 18/7 T2, 27/7 T2, and so on. Critical with respect to the unambiguous distinguishability of potential ambiguities are times where the ratio of the end times of tuning periods within the maximum range are relatively similar and are, for example, at 4m/3n=28/27 or at 5m/4n=35/36. Up to at least 3 tuning periods T1, the end times of the tuning periods come close to each other up to a factor of at most 28/27=1.037, so that ambiguities can be reliably excluded.

Other exemplary number pairs for m and n are, for example, 7 and 11 or 5 and 8.

According to at least one embodiment, the intended maximum range R is at least 0.1 km and at most 0.5 km or at least 2 km and at most 10 km. The first range of values applies, for example, to trucks or motor vehicles and the second range of values applies, for example, to aircraft or ships or railroads.

According to at least one embodiment, the Lidar system is arranged to tune the emission wavelengths of the first laser and the second laser in the form of a triangular variation or in the form of a sawtooth variation. In the case of sawtooth variation, discontinuities and/or undifferentiable spots may occur in the temporal course of the emission wavelengths at the end of the tuning periods. With a triangular variation, at least discontinuities can be avoided.

According to at least one embodiment, the first laser and the second laser have different tuning slopes. The tuning slopes are defined as wavelength difference per time unit within the respective tuning periods. Alternatively, the lasers may have equal tuning slopes.

According to at least one embodiment, the Lidar system further comprises a third laser and a fourth laser, wherein the third laser in a third wavelength range and the fourth laser in a fourth wavelength range are configured for periodically tuning a respective emission wavelength. In this regard, the first, second, third, and fourth wavelength ranges differ from each other in pairs and do not overlap each other.

Accordingly, the detection unit is also configured to detect laser radiation from the third and fourth lasers, in the same way as for the first and second lasers.

According to at least one embodiment, the third laser and the first laser form a first laser pair and the fourth laser and the second laser form a second laser pair. Within the laser pairs, the associated tuning times may be the same, so that the lasers within each laser pair are then configured to be synchronously tuned in time. With such laser pairs, a distance measurement and a velocity measurement of objects can be achieved.

According to at least one embodiment, within a laser pair the tuning slopes are different. In other words, the lasers of the respective pair are driven in such a way that different wavelength changes per time unit are present in the respective chirp, that is, the respective wavelength change ramp.

According to at least one embodiment, the detection unit is configured to detect the wavelength ranges individually and independently of each other. For this purpose, the detection unit can comprise several detectors such as photodiodes and/or the detection unit is a pixelated detector, whereby individual pixels and/or photodiodes can detect the laser radiation of individual lasers spectrally selectively.

According to at least one embodiment, the lasers are arranged to all emit in a specific, common emission direction at a specific time. The detection unit is configured to detect the emission wavelengths from a spatial range that includes the emission direction and is larger than an angular range corresponding to the emission direction. That is, the spatial detection area may envelop the spatial emission area.

According to at least one embodiment, the lasers are configured to scan pixels, for example, in a horizontal and vertical raster. The detection unit configured to detect the emission wavelengths from a pixel currently exposed by the lasers and optionally also from at least five or at least ten and/or from at most 50 or from at most 20 pixels immediately preceding in time. That is, the detection range is not limited to the current emission range.

According to at least one embodiment, the Lidar system is configured for 0.1 μs≤T1≤2 μs or for 0.2 μs≤T1≤2 μs or for 0.2 μs≤T1≤1.1 μs. The tuning time T1 and thus also the smaller tuning time T2 can accordingly be relatively short. This applies in particular to automotive applications.

According to at least one embodiment, the lasers are formed by semiconductor lasers. The semiconductor lasers are based, for example, on the material system AlInGaAs or also on the material system AlInGaP.

According to at least one embodiment, the lasers are configured to have wavelength ranges in the near-infrared spectral range. Near-infrared refers in particular to wavelengths ≥800 nm or ≥900 nm or ≥1000 nm and/or to wavelengths ≤1.6 μm or ≤1.3 μm or ≤1.1 μm.

Furthermore, a vehicle is disclosed comprising at least one Lidar system as described in connection with one or more of the above embodiments. Features of the vehicle are therefore also disclosed for the Lidar system and vice versa.

In at least one embodiment, the vehicle comprises one or more Lidar systems. The at least one Lidar system is configured to scan an environment of the vehicle. The vehicle is, for example, a motor vehicle, a truck, a motorcycle, a ship, a train or an aircraft, or even a satellite.

In addition, a method of operating a Lidar system as described in connection with one or more of the above embodiments is disclosed. Features of the Lidar system and the vehicle are therefore also disclosed for the method, and vice versa.

In at least one embodiment, the method is configured for operating a Lidar system and comprises:
scanning pixels of a solid angle region with the lasers, and
detecting laser radiation of the lasers coming from pixel areas,
   wherein laser radiation from pixel areas which have been previously scanned is also taken into account in a distance determination and/or a velocity determination of an object which reflects the laser radiation back to the Lidar system.

### BRIEF DESCRIPTION OF THE DRAWINGS

In the following, a Lidar system described herein, a vehicle described herein, and a method described herein are explained in more detail with reference to the drawing using exemplary embodiments. Identical reference signs indicate identical elements in the individual figures. However, no references are shown to scale; rather, individual elements may be shown exaggeratedly large for better understanding.

In the Figures:

FIGS. 1 and 2 show schematic illustrations of embodiments of Lidar systems described herein,

FIG. 3 shows a schematic representation of an example of a vehicle with Lidar systems described here,

FIGS. 4 and 5 show schematic representations of modified operating procedures,

FIGS. 6 to 9 show schematic representations of embodiments of methods for operating Lidar systems described herein,

FIG. 10 shows a schematic representation of a scanning characteristic of embodiments of Lidar systems described herein, and

FIGS. 11 to 17 show schematic representations of process steps of an embodiment of a method for operating Lidar systems described herein.

### DETAILED DESCRIPTION

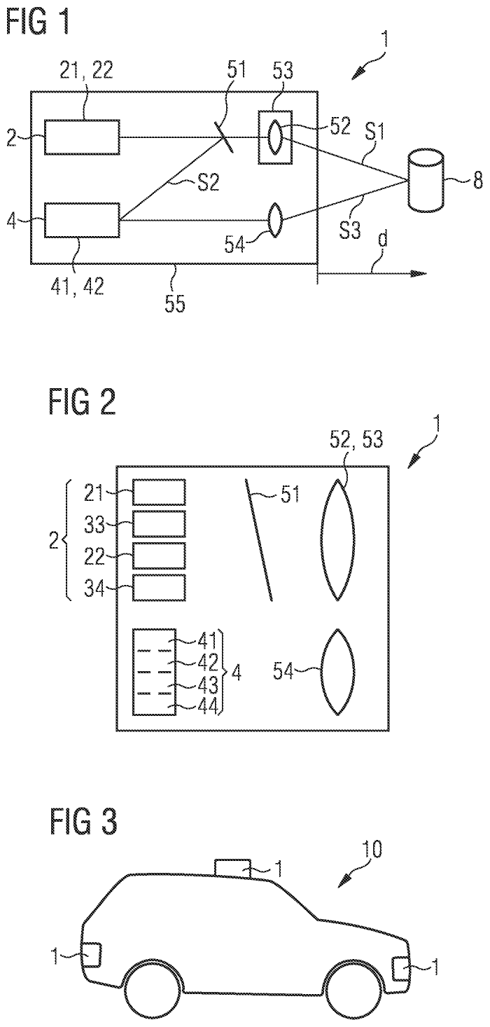

FIG. 1 shows an embodiment of a Lidar system 1. The Lidar system 1 comprises a laser system 2 with at least two lasers 21, 22. The laser system 2 emits a laser radiation S1 which is composed of radiation from the two lasers 21, 22. The lasers 21, 22 may be semiconductor lasers. Within separate wavelength ranges L1, L2, emission wavelengths E1, E2 of the lasers 21, 22 are periodically tuned. The lasers 21, 22 have a large coherence length.

The laser beam S1 reaches a beam splitter 51, which directs a beam portion S2 to a detection unit 4, which has several detection areas 41, 42 for the wavelength ranges L1, L2 of the lasers 21, 22. The detection areas 41, 42 may be configured for spectrally selective detection of the wavelength ranges L1, L2.

Furthermore, a remaining, predominant part of the laser radiation S1 reaches an object 8 outside the Lidar system 1 through the beam splitter 51 via an emission optics 52 and via an optional scanner 53. For example, a distance d of the object 8 to the Lidar system 1 is several 10 m or several 100 m. A radiation component S3 reflected at the object 8 toward a receiving optics 54 returns to the detection unit 4 and is superimposed on the radiation component S2. Since the laser radiation S1 is periodically tuned, a beat frequency in particular can be measured at the detection unit 4, from which the distance of the object 8 and/or its relative speed to the Lidar system 1 is determined.

The laser system 2 and the detection unit 4 may be located in a common housing 55.

In FIG. 2 it is shown that the laser system 2 comprises four lasers 21, 22, 33, 34, which may be arranged in two pairs 21, 33 and 22, 34. Furthermore, it is shown in FIG. 2 that the detection unit 4 has four detection areas 41, 42, 43, 44 for wavelength ranges L1, L2, L3, L4 of the lasers 21, 22, 33, 34 that are different from each other in pairs. The lasers 21, 22, 33, 34 can emit monomode.

Furthermore, in deviation from FIGS. 1 and 2, it is equally possible that the reflected light S3 is collected via the same mirror with the same optics. In this case the incident light S3 is separated from the emitted light S1, for example, by an optical circulator.

The movable scanner 53 may be a mechanical mirror, for example, a rotating mirror, or a micromechanical mirror, or MEMS mirror for short. Such a MEMS mirror can be operated in resonance or non-resonance. In resonance, larger deflections can be achieved, but the speed of movement cannot be controlled. Non-resonant movement of the mirror, on the other hand, can be controlled almost at will.

The propagation of the light S1, S2, S3 within the Lidar system 1 can be done in free-beam optics. In an embodiment, however, fiber optics is used, that is, from the laser system 2 to the emission optics 53 as well as from the receiving optics 54 to the detection unit 4, the light S1, S2, S3 may be guided in monomode fibers. An additional branched light beam is often guided over a longer fiber and mixed with the reference light and detected on a further detector. The resulting fixed travel path difference can be used to measure a modulation of the lasers 21, 22, 33, 34 and/or to adjust it in a control loop with driver electronics.

FIGS. 1 and 2 show the Lidar systems 1 only schematically. Details of assembly variants and usable components can be found, for example, in documents WO 2020/081188 A1, WO 2019/205163 A1, US 2018/0284236 A1 or US 2019/0257927 A1, the disclosure content of which is incorporated by reference with respect to the usable assembly variants and components.

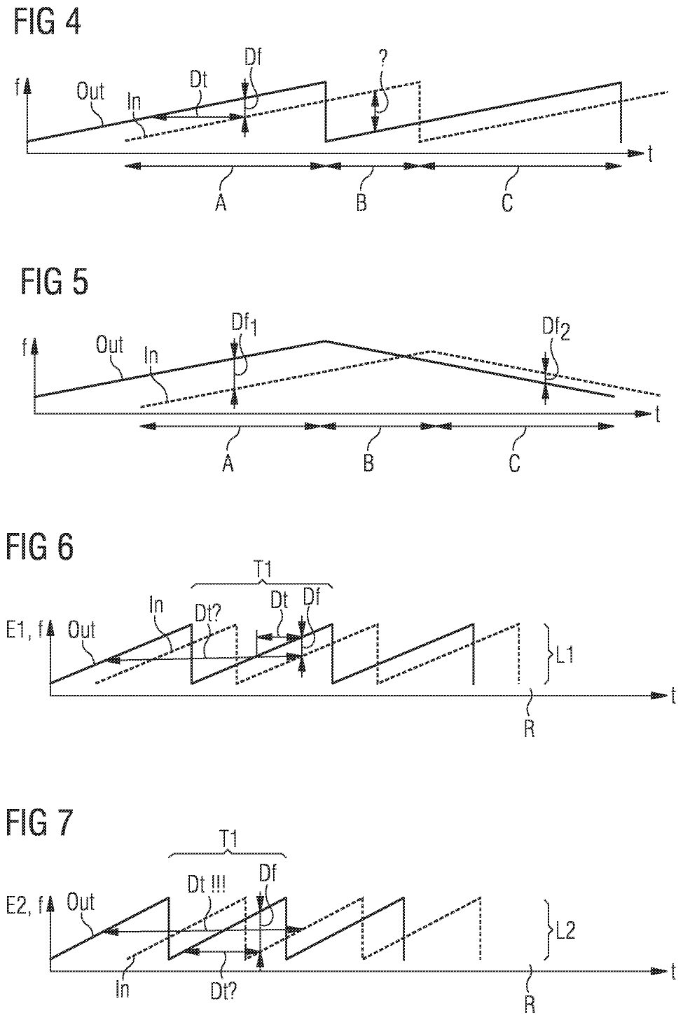

In FIG. 3, a vehicle 10, for example, a car, is shown. The vehicle 10 comprises several of the Lidar systems 1 scanning an environment of the vehicle 10. Using the method described below, high tuning rates and thus high spatial resolutions can be achieved.

Thus, the Lidar systems 1 described herein are each, in particular, a frequency modulated continuous wave Lidar, also referred to as an FMCW Lidar, which provides accelerated scanning at multiple wavelengths. FMCW Lidar thus stands for Frequency Modulated Coninuous Wave Light detection and ranging. The Lidar system 1 is particularly applicable in automotive, aerospace, defense, and general metrology applications to perform range measurements and velocity measurements. Thus, a scanning FMCW Lidar system may be implemented, with which individual image points, also referred to as pixels, can be recorded in a shorter time than the light travel time to the object 8 and back.

In an FMCW Lidar system described herein, a laser 21, 22 emits a continuous laser beam whose light frequency is periodically modulated, such as the frequency increasing or decreasing linearly over a certain period Tc. Such an increase or decrease is also referred to as a chirp; the terms tuning time and chirp duration or chirp are synonymous in this respect. The emitted laser radiation S1 is thus emitted via the optics 52, reflected at an object 8 whose distance and/or speed is to be determined, and a portion S3 of the laser radiation is collected again via the receiver optics 54. This collected laser radiation S3 is mixed with the reference light S2, also referred to as the local oscillator, which is branched off from the radiated laser radiation S1, and the mixed light is detected on a fast photodetector, that is, the detection unit 4.

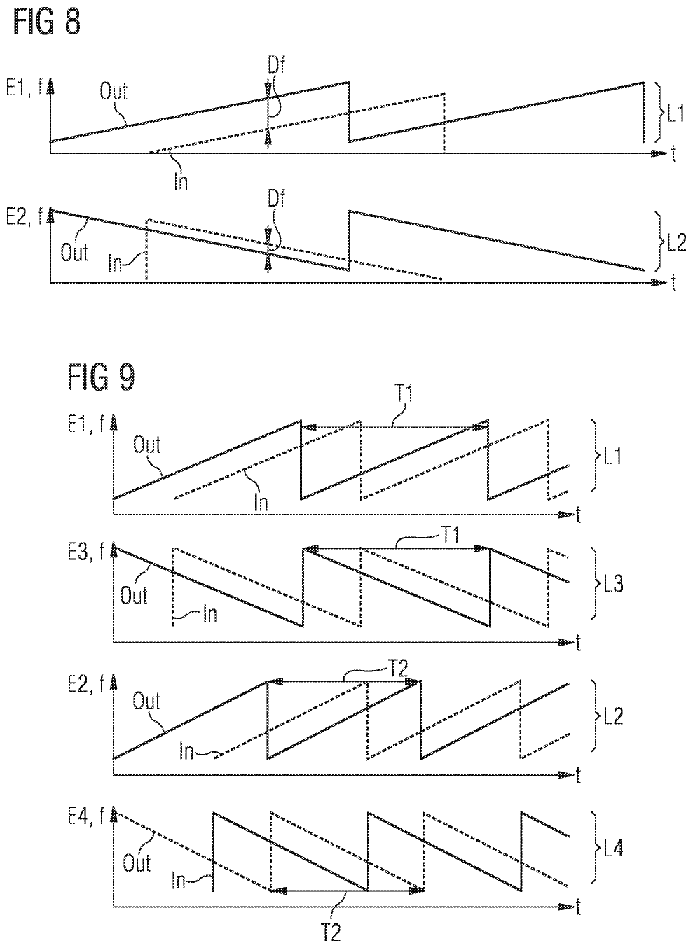

Due to the different travel paths of the reference light S2 and the light S1, S3 reflected at the object 8, as well as due to the frequency, which may vary linearly in time, corresponding to the wavelengths, the reference light S2 and the reflected light S3 have different frequencies and thus different wavelengths, see also FIG. 4. This leads to a beat, that is, to a periodic change in the intensity of the detected mixed light S2, S3. The beat frequency corresponds to the difference frequency Df, and this is proportional to a travel distance difference Dt of the laser beams S2, S3 and thus to the distance to the object 8. The beat frequency is measured by recording the signal of the detection unit 4 and thus calculating a Fourier transform. This automatically filters out influences from background light and other sources of interference, since these are not coherent with the laser radiation S2, S3 and thus do not contribute to the beat.

If the object 8 to be measured moves relative to the measuring device 1, the Doppler effect leads to a change in the measured differential frequency Df and thus to a falsification of the result for the distance in the case of a single measurement. A correction and thus a simultaneous measurement of the relative velocity is possible by emitting a second chirp with opposite slope, see also FIG. 5. Here the relative velocity has the opposite effect, so that it can be calculated from the difference Df1−Df2 of the two difference frequencies. The distance results from their mean value (Df1+Df2)/2.

This measuring principle normally forces to choose a chirp period, that is, a tuning time, which is longer than the transit time Dt of the light S1, S3 to the object 8 and back. This is the only way to reliably measure the interference of the returning light S3 with the reference light S2 within the same chirp, that is, within the same tuning period. Since a second chirp with opposite slope is required for the velocity measurement, this doubles the required measurement period, see FIG. 5, the frequency range with negative slope.

For the case that two objects are illuminated at the same time and thus in each measurement two difference frequencies are measured, which is well evaluable by means of Fourier analysis, still a third chirp with changed gradient is needed, in order to obtain a clear result, not drawn. The reason for this is that it is generally not possible to determine the correct assignment of the frequencies to the objects for two measured difference frequencies Df1, Df2 in each case. For example, if two identical difference frequencies are measured in each of the two chirps, with opposite slopes, this may indicate two static objects. However, the same signal is obtained if the two objects are at the same distance but have opposite relative velocities, that is, one object is moving away from the measuring device, the other toward the measuring device. A third chirp with a different slope, where a constant frequency also serves this purpose, then provides data that fit only one of the two possible interpretations and thus solves the problem of the lack of uniqueness.

Thus, this concept requires a measurement duration and tuning time that is greater than three times the light travel time to object 8 and back, especially since, with a variable slope of the frequency change in the chirp, only the time after the re-arrival of the same chirp from the object can be used for recording the time dependence of the beat signal, since before that the difference frequency is not constant and this does not result in a usable Fourier transform. The time duration of the signal recording corresponds to the integration time of the distance measurement. In order to be able to determine the difference frequency or frequencies with sufficient accuracy by Fourier analysis, a sufficient integration time is required.

Thus, in a first time range A and in a third time range C according to FIG. 4, measurements of the distance are possible, and in an intermediate second time range B measurements are possible at least if information about the chirp phase is available, for example, from a driver or a control unit, see FIG. 4. In contrast, a speed measurement according to FIG. 5 is only possible in the ranges A and C, but not in range B.

Thus, the simplest operating mode for static situations is shown in FIG. 4: The frequency f of a laser increases linearly, is reduced to the minimum value in a very short time when the maximum value is reached at the end of the first time range A, and then increases linearly again. Likewise, the frequency f could also fall linearly, this does not change the basic operation. One period of this frequency progression can be called the chirp or tuning time. The light S3 reflected from object 8 shows the same frequency course, only shifted in time by the transit time of the light to object 8 and back. This results in a constant frequency difference Df to the emitted light from the time the light returns from object 8 until it reaches the maximum frequency, see the third time range C in FIG. 4.

For this method, there must be sufficient temporal overlap of the continued linear rise of the emitted light S1 with the returning rise to be able to determine the beat frequency from the measurement data with the required accuracy. For this, the duration of the chirp, that is, the tuning time, must be greater than the transit time of the light to the object 8 and back, as explained above. If this is not true, in principle, assuming a strict periodicity of the successive chirps, the difference frequency between the previous returning chirp and the beginning rise of the next chirp in the second time domain B could be determined. This frequency is the difference between the frequency sweep of the chirp and the difference frequency being sought. Since the time of the start of the chirp, that is, in FIG. 4 the smallest frequency, at the emitted beam S1 is known in the system and can be used as a trigger of such a measurement, a distinction which of the two difference frequencies is measured is in principle possible. Thus, in principle, the entire time duration of strictly periodic chirps can be used for the measurement of the difference frequency and thus of the distance, and thus also the second time range B, even if usually only the overlap within the same chirp is used.

However, if a relative movement of the object 8 to the measuring device cannot be excluded, this measurement according to FIG. 4 is not sufficient, because the Doppler effect causes a frequency shift of the reflected light, which provides an unknown contribution to the measured difference frequency. In this case, the measurement according to FIG. 5 is performed. Here, two chirps with opposite linear slopes are used. From the two determined difference frequencies Df1 and Df2, the velocity can be calculated from Df1−Df2 and the distance from (Df1+Df2)/2 as explained above.

In this mode according to FIG. 5, the measurement is only possible in the time ranges A and C in which the emitted chirp overlaps with the same returning chirp. During the time overlap with the preceding chirp in the second time domain B, the difference frequency changes with time due to the different slope, which means that after the necessary integration over a time sufficient for Fourier analysis, a unique difference frequency can no longer be measured.

Now, in the methods of FIGS. 4 and 5, if the emitted laser beam is to be moved over an optical system 53 and scanned in order to obtain a three-dimensional image by means of several successive distance measurements, the speed of the scanning process must be selected low enough so that there is sufficient time for the measurement of each individual pixel. This limits the achievable spatial resolution and/or the frequency with which the image can be repeated, that is, the image rate, also referred to as frame rate.

An example: If the Lidar system is to cover a range of 200 m, the time for the double travel distance, that is, to object 8 and back to the Lidar system 1, is approximately 1.33 μs. With 0.66 μs integration time, the required chirp duration Tc is 2 μs and this results in a minimum measurement duration of 6 μs per pixel. If a new image is to be acquired every 30 ms, the system can generate a maximum of 5000 image points, not yet taking into account any time loss due to the movement of the mirror.

The typical requirements of 3D cameras for automotive applications are much higher image resolutions up to the megapixel range, which cannot be achieved with such a system with only one wavelength for fundamental reasons.

Alternative ways to achieve higher resolution are to combine multiple FMCW Lidar systems and compose the low-resolution images generated from them into a high-resolution overall image. However, this is associated with high costs, since several Lidar systems are necessary.

In the Lidar system 1 described here, on the other hand, a higher spatial resolution is made possible by a parallel measurement with several wavelengths at the same image point and with a different slope of the frequency change for each wavelength, so that a measurement period per image point is reduced. A wavelength difference between the wavelength ranges of the lasers may be larger than the wavelength variation during one chirp, that is, within one tuning period.

Thus, the Lidar system 1 described herein includes, in particular, the following two aspects that can be combined:
1. A simultaneous measurement with opposite, but equal, slope of two frequency chirps: thus, the two chirps required for the distance measurement and for the velocity measurement are performed in parallel, directly halving the measurement time. Furthermore, this allows the slope of each chirp of the same wavelength to always remain the same. That is, each chirp can be sawtooth-like.

This makes it possible in principle to use the entire time span of the chirp for the measurement with a strict periodicity of the chirps generated by the laser, whereby the integration time can effectively become almost identical to the chirp duration. In principle, to distinguish multiple objects, a third chirp from another laser with a different slope can be performed in parallel at a third wavelength.
2. The use of periodic sawtooth-shaped chirps with different periodicity as well as with a tuning time that is shorter than the time required for the emitted laser beam to return from the object 8 to be measured to the detection unit 4: If only a single chirp were used here, there would be an ambiguity in the measured distance, since the same frequency difference from the local reference light S2 would result for several distances. The use of two different periods of the chirps, that is, tuning times, in parallel allows the resolution and elimination of ambiguities.

This enables measurement using chirps that have a smaller duration than the light travel time to the object 8 and back to the detection unit 4. Another option is that this enables a larger slope of the chirps, that is, the change in wavelength over time, which can reduce an absolute distance measurement error.

To determine the difference frequency or frequencies in each individual signal, it is possible with the method described here to use almost the entire duration of the chirp to obtain a sufficient integration time. For this purpose, all chirps may run in a sawtooth shape with the same orientation of the slopes. At the beginning of each emitted chirp, where a phase position of the received chirp is distance-dependent and thus unknown, this results in a measured difference frequency that just corresponds to the difference between a modulation deviation and the sought difference frequency. After the arrival of the chirp in the sawtooth, the sought difference frequency is measured directly. With this knowledge, almost the entire chirp duration can be used as integration time by suitable algorithms, for example section-wise Fourier transform, variation of the calculation interval in the Fourier transform or the like.

In combination, this results in a measurement with four wavelengths, two each with different periodicities, one of which has the opposite sign of the slope of the other, see also FIG. 9. If the magnitude of the slopes is adjusted together with the periodicity, which can be done automatically if the total frequency deviation is kept constant, the different slopes also allow the resolution of ambiguity for multiple objects, so that no additional chirp or laser is required for this. This method allows the measurement of distance and velocity of multiple objects at the same pixel in a time that can be significantly shorter than the light travel time to object 8 and back.

For this purpose, each pixel is illuminated only for at least the duration of the longer chirp. After that, the illumination unit, that is, the laser system 2, already changes to the next pixel, while the lasers continue to emit the sawtooth-shaped chirp periodically. The detection unit 4, comprising the two or the four detection areas 41, 42, 43, 44, that is, one detection area per wavelength, detects several image points, possibly even the entire field of view to be scanned, that is, the entire scanning area of the Lidar system, simultaneously. If a signal consisting of the four partial signals from the four wavelengths is received at the detection unit 4, the distance and speed of the object 8 to the Lidar system and relative to the Lidar system 1 can be calculated from this via the Fourier transformation, possibly also for several objects 8 simultaneously.

The calculated distance can now be used to calculate the light transit time that has elapsed since the chirps were emitted from the laser system 2, and from this the scan direction in which the light was imaged and/or emitted at the time of its emission can be determined. Thus, the measured distance can be subsequently assigned to the correct image point, even if the scanner is already directed to another image point at the time of reception.

Thus, a scanning FMCW Lidar system 1 can be realized, with which the individual pixels can be recorded in a shorter time than the light travel time to the object 8 and back. This allows faster scanning measurements than with pulsed Lidar systems, which are distance measuring systems but do not provide information on relative velocity.

While other methods of increasing the frame rate in scanning FMCW systems rely on classical parallelization and thus achieve only an increase in the number of measurement points per unit of time proportional to the number of parallel systems, the approach described here allows the effective measurement time per pixel to be reduced to significantly less than a quarter of the individual measurement by means of, in particular, four measurements performed in parallel on the same pixel. Therefore, the method described here is particularly efficient and thus also offers considerable savings potential on the cost side.

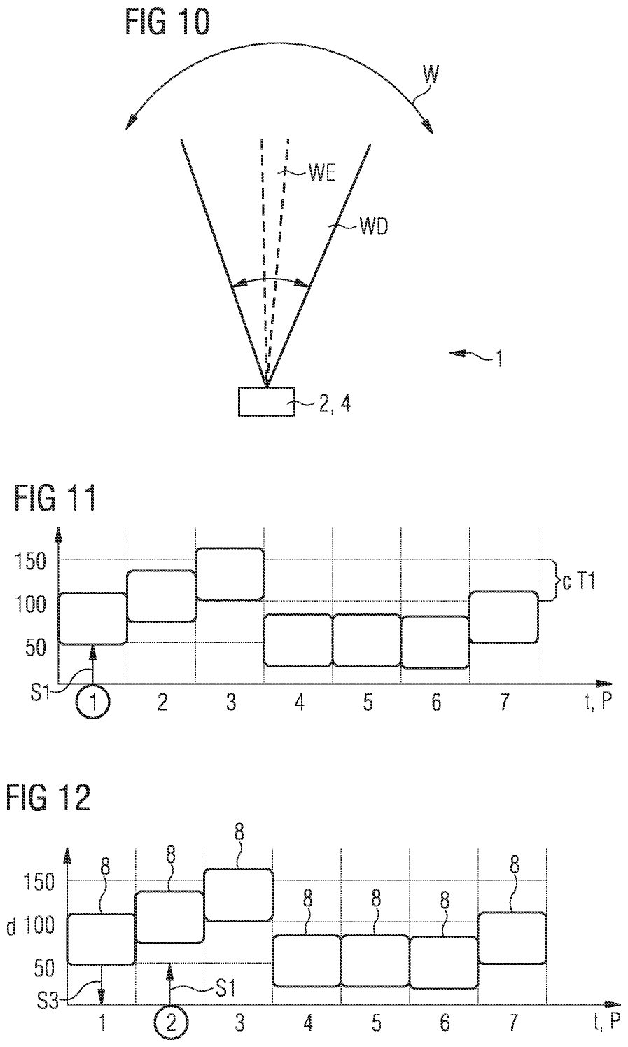

The simple operation mode according to FIG. 4 also provides an ambiguity in the distance measurement for static objects 8. This occurs when the chirp is possibly shorter than the travel time of the light to the object 8 and back. This problem is outlined in FIG. 6. Because of the periodicity of the chirps, measuring the difference frequency effectively measures a phase shift between the transmitted and received signals. If, due to the measurement sensitivity, there is a possibility that this can become greater than a whole period, it is no longer possible to determine the distance to the object unambiguously with the simple measurement.

Distances are also possible which are greater by an integer multiple of the distance corresponding to the round-trip time of a chirp period T1. Therefore, in conventional systems, the chirp period is chosen so long that this ambiguity only occurs at distances at which detection is no longer possible even for highly reflective objects.

For example, the tuning time T1, within which the emission wavelength E1 is linearly tuned once through the wavelength range L1, corresponds to a distance to the object 8 of 50 m. The frequency difference Df corresponds to a distance of 30 m, but also matches time differences Dt for 80 m, 130 m, 180 m, 230 m, and so on. Since the tuning time T1 is smaller than R/c, where R is an intended maximum range of the Lidar system 1 and c is the speed of light, ambiguities arise.

A workaround is shown in FIG. 7: A second chirp is emitted in parallel with a second emission wavelength E2 in a second wavelength range L2 with a different tuning time T2. This results in a second series of distance values from the difference frequency from this second measurement.

For example, the tuning time T2 corresponds to a distance to object 8 of 40 m. The frequency difference Df corresponds to a distance of 20 m, but also matches time differences Dt for 60 m, 100 m, 140 m, 180 m, 220 m and so on.

A comparison with the distances from the corresponding list of possible distances from the first measurement, or an equivalent mathematical procedure, leaves only one distance that matches the measurement of both wavelengths. In the present example, this is a distance of 180 m. An ambiguity results only from the smallest common multiple of the individual ambiguity distances. Accordingly, the tuning times T1, T2 are to be selected in such a way that such ambiguities occur only outside the maximum intended range R.

This method allows distance measurement with chirps that last shorter than the maximum measurable round trip time of the light to the object 8 and back to the Lidar system 1. Thus, larger gradients of the frequency over time are possible with a constant frequency deviation. A constant measurement error of the frequency thus results in a smaller measurement error in the transit time and thus a higher accuracy of the distance measurement.

A measurement with multiple wavelengths can be performed by using a second or third laser and a second or third detector. The local oscillator can also be designed separately for each wavelength, but can also be shared. In other words, the light for the reference beam can be diverted before or after combining the radiation from the two or more lasers. Between the receiver optics and the detectors, the light has to be separated depending on its wavelength, for example, by a grating, a prism or a prefabricated device as used for wavelength demultiplexing in telecommunication applications. The mixing with the reference light of the local oscillator can be done before or after the wavelength selective element.

Separate emitter optics for each wavelength is possible, but not necessarily to be provided for reasons of size and cost. The receiver optics may be used together for all wavelengths.

Another example is shown in FIG. 8, where a measurement is made with two different slopes. If a velocity measurement is required, two different slopes of the chirp are necessary to distinguish between distance influence and relative velocity influence on the difference frequency. The evaluation is simplest when opposite chirps are used. If two wavelengths are available, the measurements can be performed with both slopes in parallel. This means that a sawtooth-shaped chirp can be used for each individual measurement in turn, so that each time interval and each phase can be used for a measurement of the difference frequency.

In the example of FIG. 9, a combination of different periods and slopes is used. Thus, FIG. 9 shows a combination of the application examples of FIGS. 6, 7 and 8. By simultaneously using four emission wavelengths E1, E2, E3, E4 in four wavelength ranges L1, L2, L3, L4, distance and speed can be measured with chirps that can be shorter than the light travel time to the object and back. The emission wavelengths E1, E3 and E2, E4 have the same tuning times T1 and T2, respectively.

One period of the chirp with the longer period T1 is sufficient for the measurement. The lower limit of the possible measurement time results solely from the achievable or required measurement accuracy, which in turn is limited by the laser power that can be used. If a very high laser power is possible, because the eye safety according to laser class 1 can be exceeded due to the application, very short measurement durations are possible, for example, when using Lidar from airplanes. Since very large distances often have to be measured in such applications, with correspondingly long light travel times, the advantage of this method is particularly obvious here.

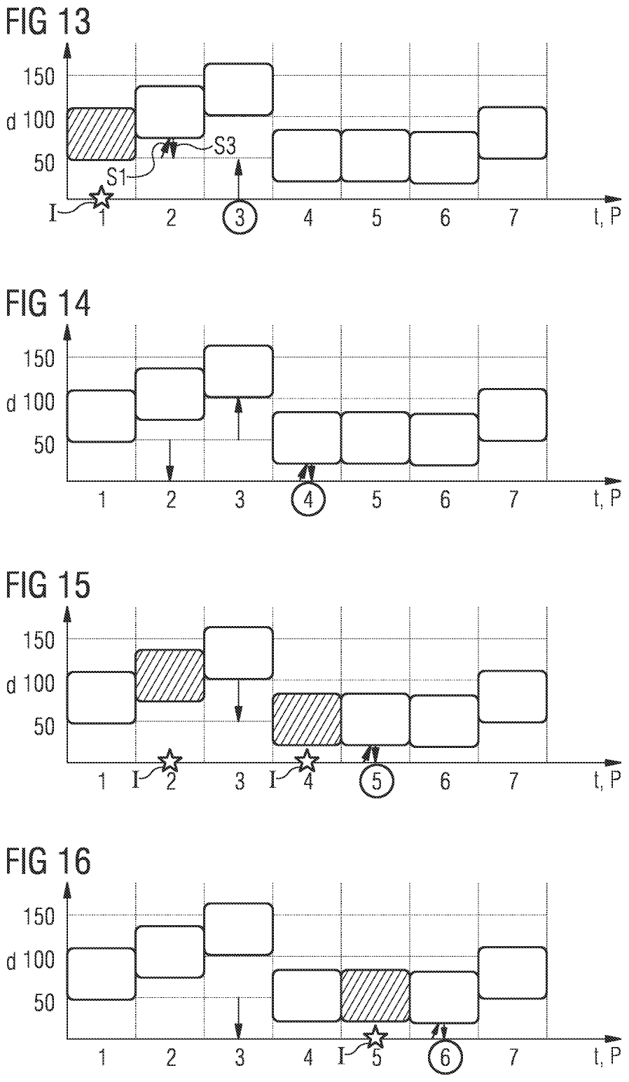

However, a realistic speed advantage also results already in the range of distances of a few 100 m, as they are typical with eye-safe lasers, for example, in the automotive sector. If this method is used in a scanning system, the emitted laser beam can be directed to the next measuring point after a chirp period of the longer chirp with duration T1. Of course, the detector optics must still be able to receive light from the previous emission direction, see FIG. 10.

Thus, the Lidar system 1 of FIG. 10 has a scanning range W. A detection angle range WD of the detection unit 4 is smaller than the scan range W and is thus tuned in time.

Alternatively, the detection angle range WD can also be equal to the scan range W. A comparatively narrow emission angle range WE lies within the detection angle range WD and is smaller than the detection angle range WD. The size of the emission angle range WE provides the tangential spatial resolution of the Lidar system 1. The emission angle range WE is scanned across the scanning range W.

This can be realized by different emitter optics and detector optics or also by a fixed detector optics. If the method is combined with a non-resonant mirror, the measurement duration can be adapted to the requirements depending on the situation. For example, with a high scanning speed and short measurement duration per pixel, a high frame rate with reduced range can be realized. If the measurement duration is extended, for example, by adjusting the chirp duration or by integrating it over several chirps, and scanning is correspondingly slower, the precision and range of the measurement can be increased in selected image areas.

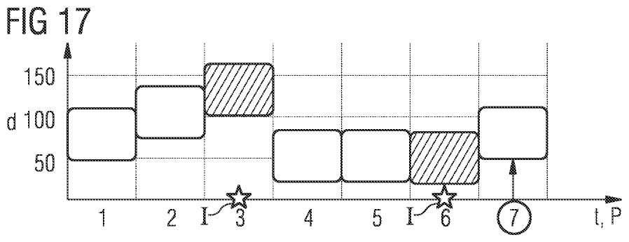

When evaluating such a measurement, where the signal from the object 8 is received only after the emitter has been scanned further, the measured distance can be used to calculate back to the pixel position of the object 8. The related method is shown in FIGS. 11 to 17, in which a sequence of a scanning process is shown in time steps. The pixel in whose direction the laser system 2 emits the laser radiation S1 in the respective time step is marked by a circle in each case.

FIG. 11 shows the first time period. The laser system 2 emits light in the direction of the pixel 1 for the duration of, for example, a chirp of the longer period T1. The light just reaches a first object 8 located in this direction during this time period. No light from an object 8 arrives yet at the detection unit 4 with the wavelength range-selective detection areas, so nothing is detected yet.

Then the laser system 2 swings in the direction of pixel 2 in the second time segment, see FIG. 12. In this time segment, the light from pixel 1 is just on its way back to the detection unit 4, but has not yet arrived there. The light from pixel 2 does not yet reach the further object 8 in the field of view of pixel 2. Once again, nothing is detected.

In time section 3, see FIG. 13, the laser beam is emitted in the direction of pixel 3. In the field of view of pixel 2, the laser radiation S1 is just reflected at the object 8 there. The light emitted in the area of pixel 1 arrives at the detection unit 4 and is measured. This detection event I is symbolized by a star.

Since the detector optics receives the light from a wider range of angles together, the detection unit 4 does not provide the information about the direction from which this signal was received. However, the detection unit 4 provides the information about the distance. From this, it can be calculated via the speed of light how long the just detected laser radiation S3 was on the way. From this time and the current scan position, it can be calculated back in which direction the just detected laser radiation was emitted. From this, the angular position of the detected object 8, in this case pixel 1, is determined.

FIGS. 14 to 17 show examples of the further course of the measurement. It should be noted, see FIGS. 15 and 17, that the detection unit 4 is capable of simultaneously detecting several signals from different distances. Two reflected signals with different difference frequencies then arrive here, which leads to a superposition of the beatings. The two frequencies can be determined in Fourier analysis. By using two different slopes of the chirps, velocity and distance can be determined unambiguously from both objects 8.

Thus, both detected objects 8, which are located in the area of pixels 2 and 4 according to FIG. 15 and located in the area of pixels 3 and 6 according to FIG. 17, can be regarded separately in the described measuring method. This means that for each object 8, the light travel time is determined separately from the distance and from this the emission direction and thus the associated pixel and the associated object position.

For example, the detection events I in the time step to pixel 5 of FIG. 15 provide distances of 25 m and of 75 m, from which it follows that the objects 8 in question are one pixel or three pixels behind in the time domain and are thus to be assigned to pixels 2 and 4. Similarly, the detection events I in the time step to pixel 7 of FIG. 17 provide, for example, distances of 25 m and of 100 m, from which it follows that the objects 8 in question are one pixel or four pixels behind in the time domain and are thus to be assigned to pixels 3 and 6.

The invention described herein is not limited by the description based on the embodiments. Rather, the invention encompasses any new feature as well as any combination of features, which in particular includes any combination of features in the patent claims, even if this feature or combination itself is not explicitly stated in the patent claims or embodiments.

### LIST OF REFERENCE SIGNS

1 Lidar system
2 laser system
21 first laser
22 second laser
33 third laser
34 fourth laser
4 detection unit
41 . . . 44 detection range
51 beam splitter
52 emission optics
53 scanner
54 receiving optics
55 housing
8 object
9 modified Lidar system
10 vehicle
A first time range
B second time range
C third time range
c speed of light
d distance
Dd frequency difference or difference frequency
Dt runtime difference
f frequency as a measure of the wavelength
E emission wavelength
I detection event
In received laser radiation reflected from the object
Out laser radiation emitted to the object
L wavelength range
P pixel
S laser radiation
R intended maximum range
t time
T tuning time
W scan area
WD detection angle range
WE emission angle range

1. A Lidar system comprising:
a first laser and a second laser; and
a detection unit for detecting laser radiation of said first and second lasers;
wherein:
the first laser in a first wavelength range and the second laser in a second wavelength range are configured for periodic tuning of a respective emission wavelength; and
a first tuning time T1 of the first laser differs from a second tuning time T2 of the second laser.

2. The Lidar system according to claim 1,
wherein T1>T2 and T1/T2 ranges from 1.05 to 1.95, inclusive.

3. The Lidar system according to claim 1,
wherein at least one of the tuning times T1 and T2 is smaller by at least a factor of 2 than an intended maximum range R of the Lidar system divided by the vacuum light velocity c.

4. The Lidar system according to claim 1,
wherein m T1=n T2 with m, n∈ [symbol] and m<n and n/m∈ [symbol] \ [symbol] ,
where for all i=1, . . . , n and for all j=1, . . . , m it holds:
$$\frac{im}{jn} \leq 0 , 97 ⋀ 1 , 03 \leq \frac{im}{jn} ,$$
as well as m T1>F R/c and (m−1) T1<F R/c with 0.2≤F≤1.5.

5. The Lidar system according to claim 3, wherein the intended maximum range R is at least 0.1 km and at most 0.5 km.

6. The Lidar system according to claim 1, which is configured to tune the emission wavelengths of the first laser and the second laser in the form of a triangular variation or in the form of a sawtooth variation.

7. The Lidar system according to claim 6, wherein the first laser and the second laser have different tuning slopes, the tuning slopes being defined as wavelength difference per unit time, within respective tuning periods.

8. The Lidar system according to claim 1,
further comprising a third laser and a fourth laser;
wherein the third laser in a third wavelength range and the fourth laser in a fourth wavelength range are configured for periodically tuning a respective emission wavelength;
wherein the first, second, third, and fourth wavelength ranges differ from each other in pairs and do not overlap each other.

9. The Lidar system according to the claim 8,
wherein the third laser and the first laser form a first laser pair and the fourth laser and the second laser form a second laser pair;
wherein within the laser pairs the associated tuning times are the same but the tuning slopes are different so that the lasers within each laser pair are configured to be tuned synchronously in time; and
wherein the detection unit is also configured to detect laser radiation of the third and the fourth lasers.

10. The Lidar system according to claim 1,
wherein the detection unit is configured to detect the wavelength ranges individually and independently of each other;
wherein the detection unit is configured to detect the emission wavelengths from a spatial area comprising and enveloping the emission direction.

11. The Lidar system according to claim 10, wherein the lasers are configured to scan pixels, the detection unit being configured to detect the emission wavelengths from a pixel currently exposed by the lasers and from at least five pixels immediately preceding in time.

12. The Lidar system according to claim 1, which is configured for 0.1 μs≤T1≤2 μs.

13. The Lidar system according to claim 1, wherein the lasers are formed by semiconductor lasers and are configured to have wavelength ranges in the near-infrared spectral range.

14. A vehicle comprising at least one Lidar system according to claim 1,
wherein the at least one Lidar system is configured to scan an environment of the vehicle.

15. A method for operating a Lidar system according to claim 1, further comprising:
scanning pixels of a solid angle range with the lasers; and
detecting laser radiation of the lasers coming from pixel ranges, wherein in a range determination and/or in a velocity determination of an object reflecting the laser radiation back to the Lidar system, laser radiation from pixel ranges previously scanned is also taken into account.

16. A Lidar system comprising:
a first laser and a second laser; and
a detection unit for detecting laser radiation of said first and second lasers;
wherein the first laser in a first wavelength range and the second laser in a second wavelength range are configured for periodic tuning of a respective emission wavelength so that the lasers are configured for different period durations; wherein a first tuning time T1 of the first laser differs from a second tuning time T2 of the second laser; and wherein at a certain point in time, all of the lasers are configured to emit in a certain common emission direction.
